(19) United States
(12) Patent Application Publication
(10) Pub. No.: US 2026/0115099 A1
(43) Pub. Date: Apr. 30, 2026

(54) VIAL HOLDER

(71) Applicant: JANSSEN PHARMACEUTICALS, INC., Titusville, NJ (US)

(72) Inventors: Thomas Joseph Anthony Zuber, New York, NY (US); Michael Cannamela, Atlantic Highland, NJ (US); Alan Moffat, Schaffhausen (CH)

(21) Appl. No.: 18/858,778

(22) PCT Filed: Apr. 18, 2023
(86) PCT No.: PCT/IB2023/053970

§ 371 Date: Oct. 22, 2024

Related U.S. Application Data
(60) Provisional application No. 63/333,761, filed on Apr. 22, 2022.

(51) Int. Cl. A61J 1/16

(52) U.S. Cl. CPC A61J 1/16; A61J 2205/30

(57) ABSTRACT

Various exemplary methods, systems, and devices for vial holders are provided. The vial holders are assembled from housing components with a two-step snap closure, where a first step partially assembles the vial holders into a stable first configuration to form vial slots and shelf platforms for ease of receiving vials. The vial holders are advantageous for holding and labeling vials containing temperature sensitive therapeutic formulations that need to be handled under conditions limited by time and dexterity by permitting partial pre-assembly and labeling at a remote location and facilitating final assembly with minimal effort. In some embodiments, the vial holders incorporate tamper resistant structures that physically shield the two-step snap closure from external access.

### FIELD

The present disclosure relates generally to devices for holding vials, and in particular to vial holders comprising housings assembled with a two-step snap closure.

### BACKGROUND

Certain therapeutic formulations are very temperature sensitive. These formulations are maintained in vials at very low temperatures, with processing steps such as labeling and sorting necessarily performed quickly by operators donning bulky insulated gear. Due to the constraints posed by tight timing and limited dexterity, vial handling may be facilitated by providing a holder that can be assembled and manipulated at low temperatures with minimal effort.

Accordingly, there is a need for an improved vial holder with easy assembly and improved handling.

### SUMMARY

In general, methods, systems, and devices for vial holders are provided.

In one aspect a vial holder is provided, comprising: a housing comprising a first vial slot and a second vial slot; and a first shelf and a second shelf positioned inferior to the first vial slot and second vial slot, respectively; wherein the housing is assembled from a first and an opposing second housing component, each comprising a portion of each vial slot and each shelf; wherein the housing components are attached to each other by an interior two-step snap closure engagement between at least one clip and at least one clip retainer having an outer detent and an inner detent; wherein the outer detent of each clip retainer is configured to engage a clip of an opposing housing component in a partially assembled configuration, and wherein the inner detent of each clip retainer is configured to engage a clip of an opposing housing component in a fully assembled configuration.

In one aspect, the partially assembled configuration partially forms each vial slot to receive a vial therein to rest upon each shelf.

In one aspect, the fully assembled configuration locks each received vial within each vial slot.

In one aspect, the at least one clip retainer is integrated into the first shelf portion and the at least one clip extends from the second shelf portion of each housing component.

In one aspect, the at least one clip retainer and the at least one clip are positioned between the first vial slot and the second vial slot.

In one aspect, the at least one clip retainer is positioned at two corners of each housing component and the at least one clip is positioned at opposing two corners of each housing component.

In one aspect, each of the first and second housing component comprises an inner edge that meets face to face in the fully assembled configuration to form a seam.

In one aspect, each of the first and second housing component comprises a plurality of fins positioned adjacent to and extending outwards past a segment of the inner edge.

In one aspect, the plurality of fins block the seam formed by the inner edges from exterior access in a fully assembled configuration.

In one aspect, the plurality of fins forms a tamper-resistant barrier to the two-step snap closure by blocking exterior access.

In one aspect, each vial slot is connected to at least one window.

In one aspect, an inferior face of the housing comprises one or more vents fluidly connected to an interior of the housing.

In one aspect, an exterior surface of the housing is configured to receive one or more labels.

In one aspect, the first and second housing components are identical.

In one aspect, the first and second housing components are non-identical.

In one aspect, a method of assembling and loading a vial holder is provided, comprising the steps of: providing a first and second housing component, each housing component comprising a portion of a first vial slot, a second vial slot, a first shelf inferior to the first vial slot, a second shelf inferior to the second vial slot, at least one clip, and at least one clip retainer having an outer detent and an inner detent; pressing the first and second housing components together such that each clip of each housing component seats within the outer detent of each clip retainer of the opposing housing component to form a partially formed first vial slot, partially formed second vial slot, partially formed first shelf, and partially formed second shelf; positioning a vial in each of the partially formed first vial slot and partially formed second vial slot to rest on the partially formed first shelf and partially formed second shelf, respectively; and pressing the first and second housing components together such that each clip of each housing component seats within the inner detent of each clip retainer of the opposing housing component to lock each vial in a fully formed first vial slot and fully formed second vial slot.

In one aspect, the providing step and first pressing step are performed at a location separate from the positioning step and second pressing step.

In one aspect, the method further comprises a step of applying a label to the first housing, the second housing, or both, prior to the positioning step.

### BRIEF DESCRIPTION OF THE DRAWINGS

The present disclosure is described by way of reference to the accompanying figures which are as follows:

FIG. 1 illustrates a side view of a fully assembled vial holder;

FIG. 2 is a perspective view illustrating unassembled vial holder housing components of FIG. 1;

FIG. 3 is a perspective view of a partially assembled vial holder of FIG. 1;

FIG. 4 is a perspective view of the placement of vials in the partially assembled vial holder of FIG. 3;

FIG. 5 is a perspective view of a fully assembled vial holder of FIG. 4;

FIG. 6 is a perspective view illustrating another unassembled vial holder housing component of FIG. 1;

FIG. 7 is a perspective view illustrating another vial bolder housing component of FIG. 1;

FIG. 8 is a perspective view of unassembled vial holder housing components (bottom left) and a fully assembled vial holder with vial (top right);

FIG. 9 is a bottom view of a partially assembled (left) and fully assembled (right) vial holder of FIG. 8;

FIG. 10 is a perspective view of unassembled vial holder housing components (left) and a fully assembled vial holder with vial (right);

FIG. 11 is a perspective view of unassembled vial holder housing components (bottom left) and a fully assembled vial holder with vial (top right).

### DETAILED DESCRIPTION

Certain exemplary embodiments will now be described to provide an overall understanding of the principles of the structure, function, manufacture, and use of the devices, systems, and methods disclosed herein. One or more examples of these embodiments are illustrated in the accompanying drawings. A person skilled in the art will understand that the devices, systems, and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can be determined for any geometric shape. A person skilled in the art will appreciate that a dimension may not be a precise value but nevertheless be considered at about that value due to any number of factors such as manufacturing tolerances and sensitivity of measurement equipment. Sizes and shapes of the systems and devices, and the components thereof, can depend at least on the size and shape of components with which the systems and devices will be used.

Various exemplary methods, systems, and devices for vial holders are provided.

The various figures show embodiments of vial holders of the present disclosure. The devices and related methods are described herein in connection with vial holders that facilitate holder assembly, vial insertion, and labeling that would otherwise be difficult at low temperatures using bulky equipment. Advantageously, the vial holders can be labeled and partially assembled beforehand, such that low temperature operations can be limited to vial insertion and snap fitting the vial holder into a fully assembled configuration. Partial assembly is enabled by a two-step snap closure, wherein housing components clip together in a durable first configuration that forms vial slots sized to receive one or more vials. In some embodiments, the first configuration also forms shelf surfaces below the vial slots upon which the one or more received vials may stably sit without further operator input. Final assembly is achieved by pressing the housing components together from the first configuration into a second fully assembled configuration, whereby the one or more received vials are secured within the vial slots. In some embodiments, the vial holders are formed from identical halves such that complexity of manufacturing and assembly are reduced.

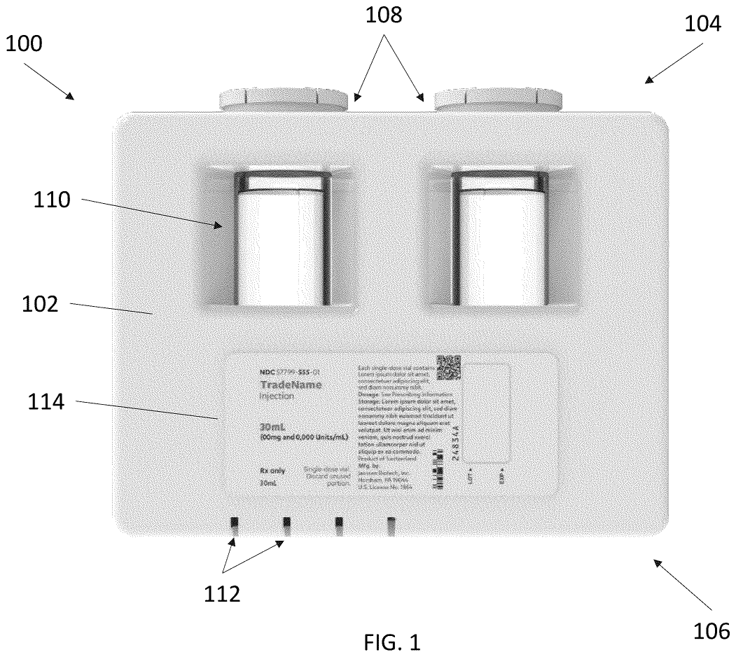

Referring now to the figures, FIG. 1 depicts an exemplary vial holder 100 according to one embodiment of the present disclosure. Vial holder 100 comprises a housing assembled from two housing components 102 each having a superior end 104 and an inferior end 106. One or more vial slots 108 are positioned at superior end 104 wherein vials secured therein are accessible. One or more windows 110 are connected to each vial slot 108 permitting visual inspection of vials secured therein. In some embodiments, inferior end 106 comprises one or more vents 112, permitting drainage of condensate. The exterior surface of each housing component 102 comprises ample label space 114. While the depicted label space 114 is shown having a sticker label attached thereto, it should be understood that any desired label or marking may be applied, including but not limited to etched labels, printed labels, molded labels, written labels, and the like.

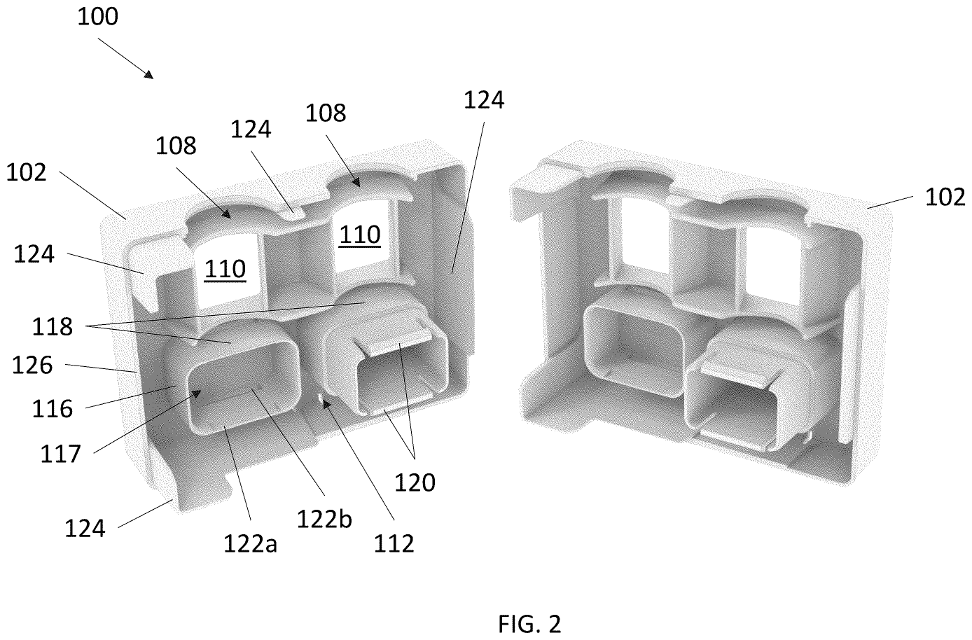

Referring now to FIG. 2, vial holder 100 is depicted in an unassembled configuration, revealing the interior of each housing component 102. Each housing component 102 comprises a portion of a shelf 116 positioned inferior to a portion of a vial slot 108 (here, each portion is depicted as half of a shelf 116 and vial slot 108), such that a vial inserted into a vial slot 108 may rest upon a superior surface 118 of each shelf 116. The two-step snap closure mechanism comprises clip retainers 117 sized to receive upper and lower clips 120. In the embodiment depicted in FIG. 2, the hollow interior of shelf 116 forms clip retainer 117, which comprises first, outer detents 122a and second, inner detents 122b. Each housing component 102 comprises a plurality of fins 124 positioned adjacent to and extending outwards past a segment of an inner edge 126. In assembly, two housing components 102 are pressed together such that inner edges 126 of each housing component 102 are brought together to meet face to face to form a seam in vial holder 100. The plurality of fins 124 are positioned in a complementary arrangement such that when two housing components 102 are pressed together, the plurality of fins 124 of each housing component 102 is configured to slide into an opposing housing component 102 such that most portions of the seam formed by the inner edges 126 comprise an adjacently positioned fin 124. Accordingly, an assembled vial holder 100 comprises fins 124 blocking the seam formed by the inner edges 126 from exterior access, thereby forming a tamper-resistant barrier against access through the seam to the snap closure mechanism formed between clip retainers 117 and clips 120.

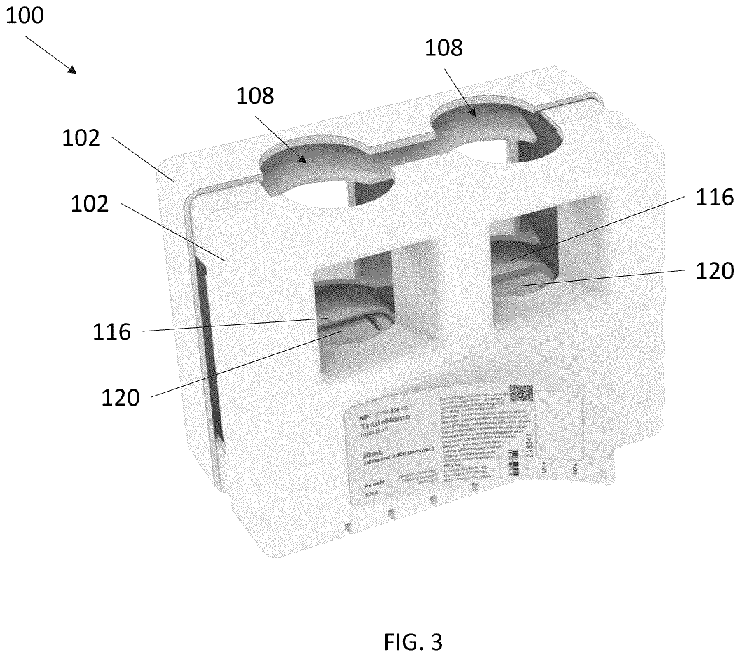

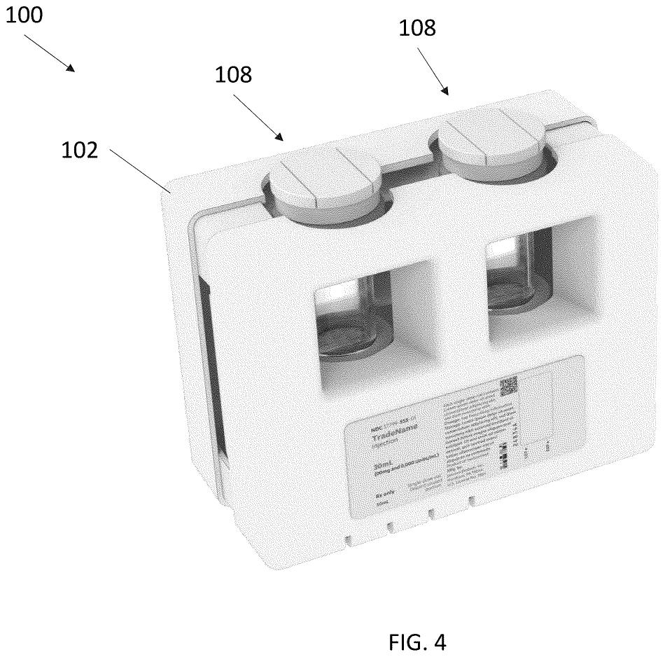

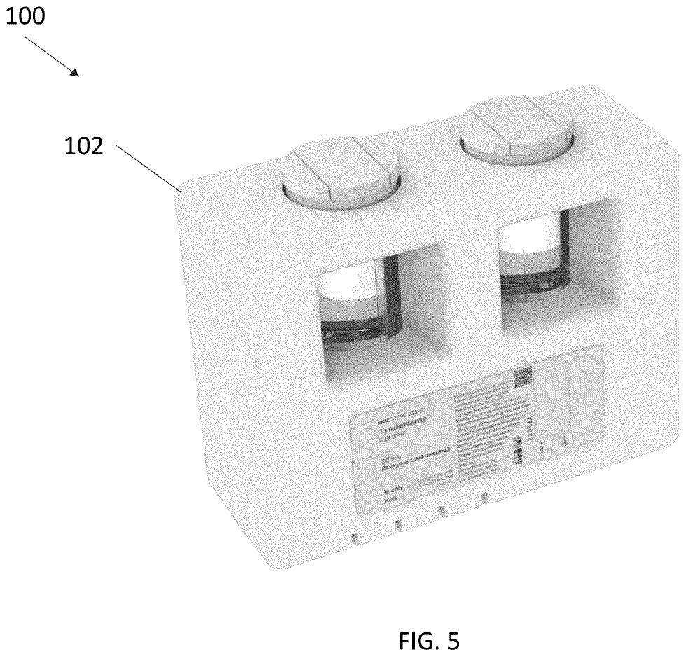

Referring now to FIG. 3 through FIG. 5, the assembly of vial holder 100 using a first and second housing component 102 is now described. As recited elsewhere herein, each housing component 102 comprises clip retainers 117 sized to receive clips 120. Accordingly, assembly is initiated by providing a first and second housing component 102 and aligning clips 120 of the first housing component 102 with clip retainers 117 of the second housing component 102, which in turn aligns clips 120 of the second housing component 102 with clip retainers 117 of the first housing component 102. The first and second housing components 102 are pressed towards each other such that clips 120 of each housing component 102 seats within first, outer detents 122a of each clip retainer 117 (the first step of the two-step snap closure), thereby fixing vial holder 100 into a first configuration (FIG. 3). In some embodiments, each vial holder 100 can be assembled into the first configuration at room temperature or any other environment prior to introduction to a low temperature environment wherein vials are stored. In some embodiments, labels may be applied to housing components 102 before or after assembly into the first configuration. In the first configuration, vial slots 108 are partially formed and shelves 116 are partially joined together below each vial slot 108 to receive one or more vials in a stable manner (FIG. 4). The first and second housing components 102 are pressed towards each other in a final step such that clips 120 of each housing component 102 seats within second, inner detents 122b of each clip retainer 117 (the second step of the two-step snap closure), closing vial holder 100 around each received vial in the fully assembled configuration (FIG. 5) with fully formed vial slots 108 and shelves 116.

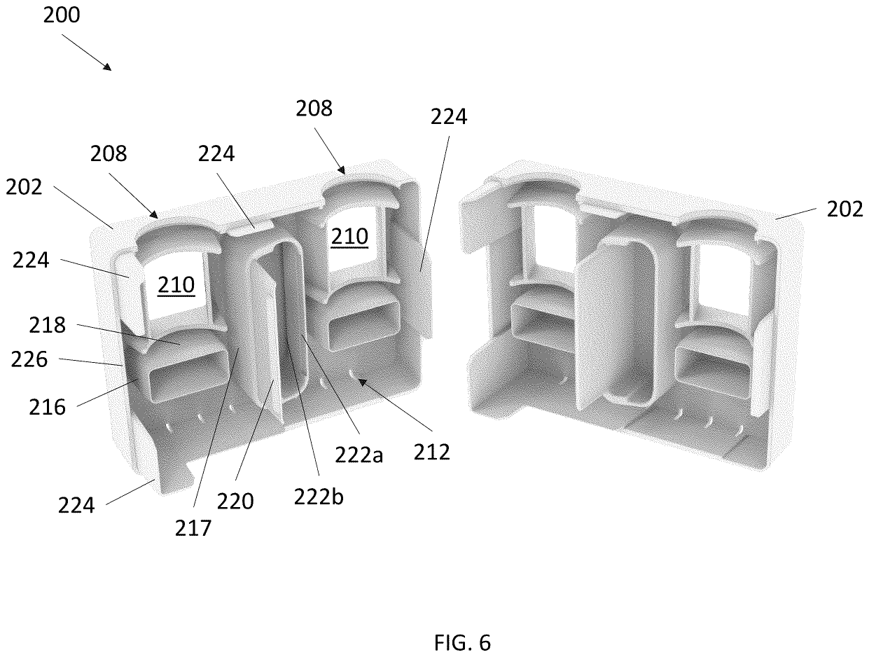

Referring now to FIG. 6, vial holder 200 is now described. Similar to vial holder 100, vial holder 200 comprises a housing assembled from two housing components 202 with a two-step snap closure. Each housing component 202 comprises a portion of a shelf 216 positioned inferior to a portion of a vial slot 208, such that a vial inserted into a vial slot 208 may rest upon a superior surface 218 of each shelf 216. Inserted vials may be visually inspected through one or more windows 210 connected to each vial slot 208. Vial holder 200 comprises a two-step snap closure mechanism between clip retainer 217 sized to receive a clip 220. In the embodiment depicted in FIG. 6, clip retainer 217 is oriented vertically adjacent to vial slots 208. Each clip retainer 217 forms a dual purpose of extending a clip 220 on one side and receiving a clip 220 on an opposing side, wherein a hollow interior of clip retainer 217 comprises a first detent 222a and a second detent 222b. First detent 222a sits at an outer position of clip retainer 217 and second detent 222b sits at an inner position of clip retainer 217. Each housing component 202 comprises a plurality of vents 212 and a plurality of fins 224 positioned adjacent to and extending outwards past a segment of an inner edge 226. In assembly, two housing components 202 are pressed together such that inner edges 226 of each housing component 202 are brought together to meet face to face to form a seam in vial holder 200. The plurality of fins 224 are positioned in a complementary arrangement such that when two housing components 202 are pressed together, the plurality of fins 224 of each housing component 202 is configured to slide into an opposing housing component 202 such that most portions of the seam formed by the inner edges 226 comprise an adjacently positioned fin 224. Accordingly, an assembled vial holder 200 comprises fins 224 blocking the seam formed by the inner edges 226 from exterior access, thereby forming a tamper-resistant barrier against access through the seam to the snap closure mechanism formed between clip retainers 217 and clips 220. Assembly of vial holder 200 using a first and second housing component 202 into a first configuration and a fully assembled configuration is performed similarly to vial holder 100 described elsewhere herein.

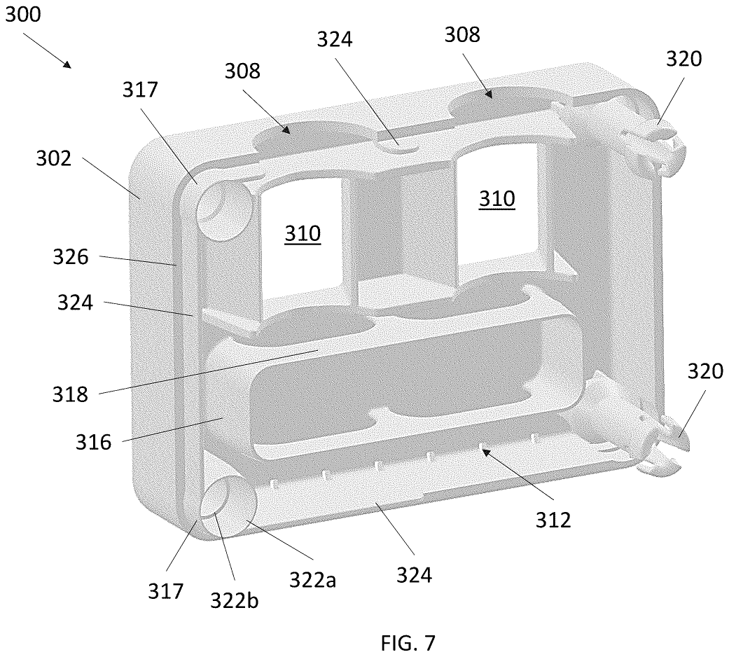

Referring now to FIG. 7, vial holder 300 is now described. Similar to vial holder 100, vial holder 300 comprises a housing assembled from two housing components 302 with a two-step snap closure. Each housing component 302 comprises a portion of a shelf 316 positioned inferior to a portion of a vial slot 308, such that a vial inserted into a vial slot 308 may rest upon a superior surface 318 of shelf 316. Inserted vials may be visually inspected through one or more windows 310 connected to each vial slot 308. Vial holder 300 comprises a two-step snap closure mechanism between clip retainer 317 sized to receive a clip 320. In the embodiment depicted in FIG. 7, clip retainer 317 is positioned at two corners of housing component 302 with pin-like clips 320 positioned at the remaining two corners of housing component 302. Each clip retainer 317 is sized to receive a clip 320 and comprises a hollow interior having a first detent 322a and a second detent 322b. First detent 322a sits at an outer position of clip retainer 317 and second detent 322b sits at an inner position of clip retainer 317. Each housing component 302 comprises a plurality of vents 312 and a plurality of fins 324 positioned adjacent to and extending outwards past a segment of an inner edge 326. In assembly, two housing components 302 are pressed together such that inner edges 326 of each housing component 302 are brought together to meet face to face to form a seam in vial holder 300. The plurality of fins 324 are positioned in a complementary arrangement such that when two housing components 302 are pressed together, the plurality of fins 324 of each housing component 302 is configured to slide into an opposing housing component 302 such that most portions of the seam formed by the inner edges 326 comprise an adjacently positioned fin 324. Accordingly, an assembled vial holder 300 comprises fins 324 blocking the seam formed by the inner edges 326 from exterior access, thereby forming a tamper-resistant barrier against access through the seam to the snap closure mechanism formed between clip retainers 317 and clips 320. Assembly of vial holder 300 using a first and second housing component 302 into a first configuration and a fully assembled configuration is performed similarly to vial holder 100 described elsewhere herein.

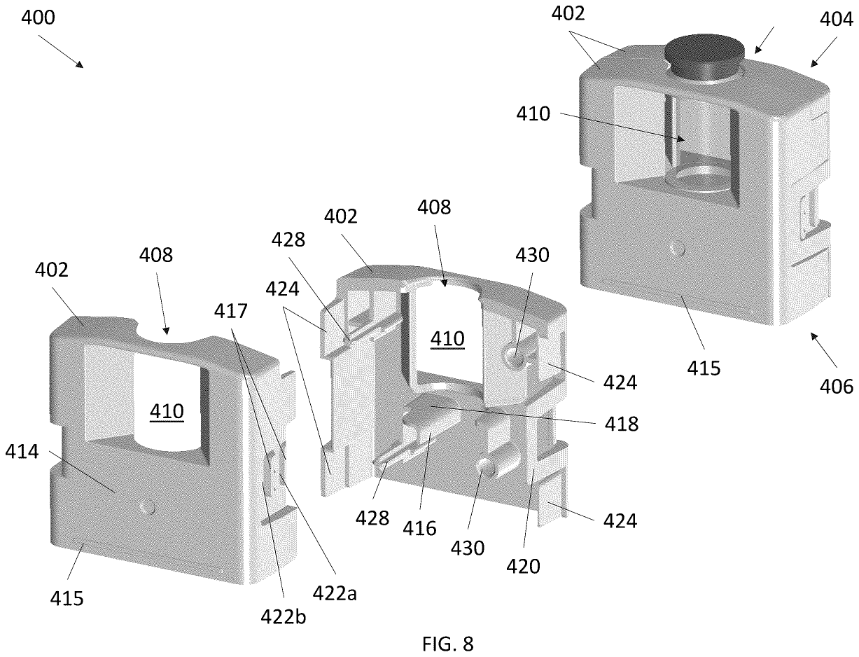

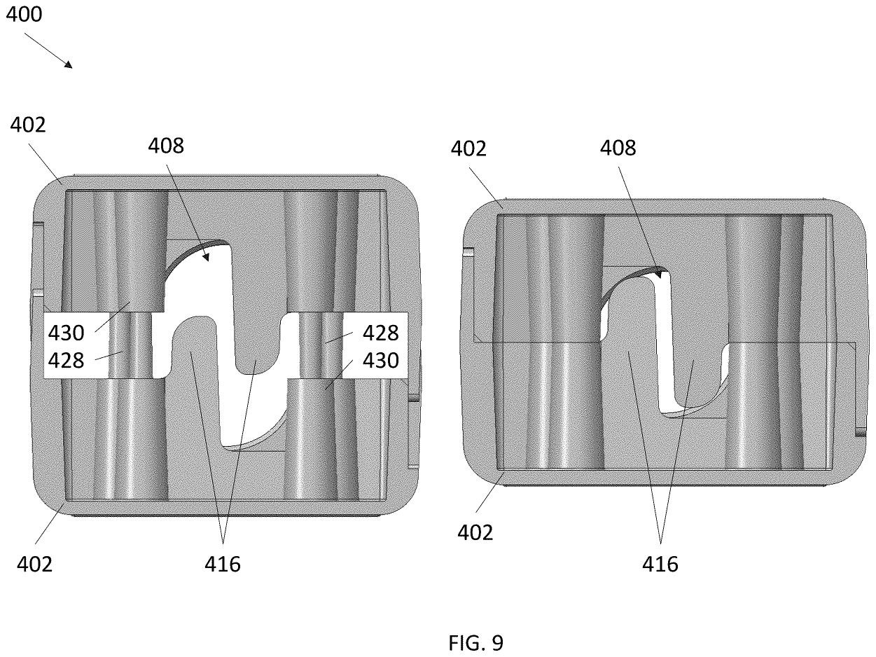

In some embodiments, the present invention relates to vial holders having external two-step snap closures. Referring now to FIG. 8, an exemplary vial holder 400 is now described. Similar to vial holder 100, vial holder 400 comprises a housing assembled with a two-step snap closure from two housing components 402 each having a superior end 404 and an inferior end 406. While vial holder 400 is shown with an open inferior end, it should be understood that closed ends and vented ends are also contemplated. Each housing component 402 comprises a shelf 416 positioned inferior to a portion of a vial slot 408, such that a vial inserted into a vial slot 408 may rest upon a superior surface 418 of each shelf 416. Shelf 416 can interlock with a shelf 416 of an opposing housing component 402 to form a larger surface to receive a vial (FIG. 9). Inserted vials may be visually inspected through one or more windows 410 connected to each vial slot 408. Vial holder 400 comprises a two-step snap closure mechanism between clips 420 and tabs 417. In the embodiment depicted in FIG. 8, housing component 402 comprises two tabs 417 configured to engage a clip 420 at a first stop 422a and a second stop 422b, wherein first stop 422a sits at an outer position and second stop 422b sits at an inner position. Each housing component 402 comprises a plurality of fins 424 that overlap each other and form a flush surface with an adjacent clip 420 in assembly. In some embodiments, vial holder 400 further comprises one or more interlocking pins 428 and pinholes 430 to enhance rigidity and facilitate assembly.

The assembly of vial holder 400 using a first and second housing component 402 is similar to the assembly of vial holder 100 described elsewhere herein. Assembly is initiated by aligning clips 420 of a first housing component 402 with tabs 417 of a second housing component 402, which in turn aligns clips 420 of the second housing component 402 with tabs 417 of the first housing component 402. If present, pins 428 of each housing component 402 are also aligned with corresponding pinholes 430 of each housing component 402. The first and second housing components 402 are pressed towards each other such that clips 420 of each housing component 402 clip over an outer tab 417 to rest at first stop 422a (the first step of the two-step snap closure), thereby fixing vial holder 400 into a first configuration (FIG. 9, left). In some embodiments, each vial holder 400 can be assembled into the first configuration at room temperature or any other environment prior to introduction to a low temperature environment wherein vials are stored. In some embodiments, labels may be applied to housing components 402 before or after assembly into the first configuration (a physical marking 415 may be provided to aid in label placement). In the first configuration, vial slots 408 are partially formed and shelves 416 are partially interlocked below each vial slot 408 to receive one or more vials in a stable manner (FIG. 9, left). The first and second housing components 402 are pressed towards each other in a final step such that clips 420 of each housing component 402 clips over an inner tab 417 to rest at second stop 422b (the second step of the two-step snap closure), closing vial holder 400 around each received vial in the fully assembled configuration (FIG. 8, top right; FIG. 9, right).

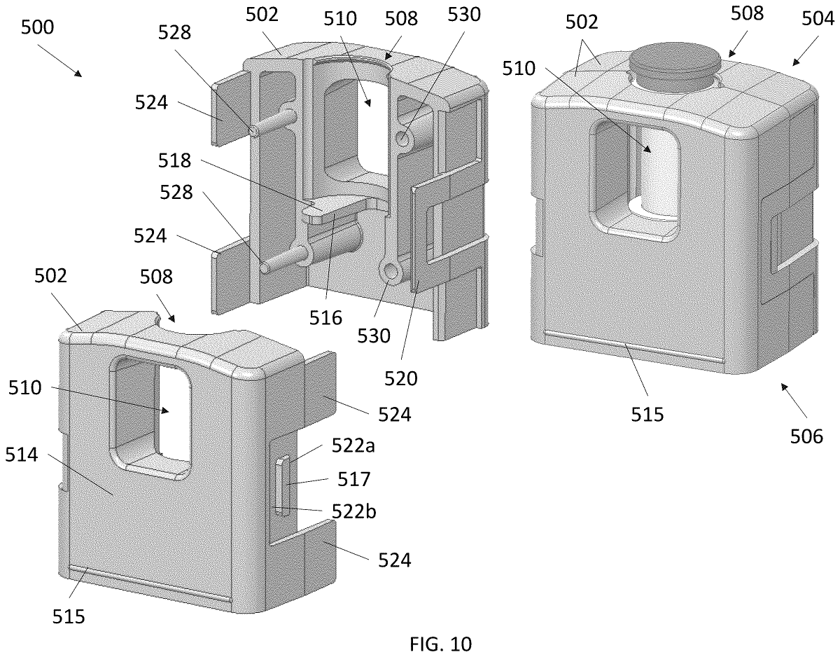

Referring now to FIG. 10, an exemplary vial holder 500 is now described. Similar to vial holder 400, vial holder 500 comprises a housing assembled with a two-step snap closure from two housing components 502 each having a superior end 504 and an inferior end 506. While vial holder 500 is shown with an open inferior end, it should be understood that closed ends and vented ends are also contemplated. Each housing component 502 comprises a shelf 516 positioned inferior to a portion of a vial slot 508, such that a vial inserted into a vial slot 508 may rest upon a superior surface 518 of each shelf 516. Shelf 516 can interlock with a shelf 516 of an opposing housing component 502 to form a larger surface to receive a vial. Inserted vials may be visually inspected through one or more windows 510 connected to each vial slot 508. Vial holder 500 comprises a two-step snap closure mechanism between clips 520 and tab 517. In the embodiment depicted in FIG. 10, housing component 502 comprises a tab 517 configured to abut against a clip 520 at a first stop 522a with a friction fit and to engage clip 520 at a second stop 522b, wherein first stop 522a sits at an outer position and second stop 522b sits at an inner position. Each housing component 502 comprises a plurality of fins 524 that overlap each other and form a flush surface with an adjacent clip 520 in assembly. In some embodiments, vial holder 500 further comprises one or more interlocking pins 528 and pinholes 530 to enhance rigidity and facilitate assembly.

The assembly of vial holder 500 using a first and second housing component 502 is similar to the assembly of vial holder 400 described elsewhere herein. Assembly is initiated by aligning clips 520 of a first housing component 502 with tab 517 of a second housing component 502, which in turn aligns clips 520 of the second housing component 502 with tab 517 of the first housing component 502. If present, pins 528 of each housing component 502 are also aligned with corresponding pinholes 530 of each housing component 502. The first and second housing components 502 are pressed towards each other such that clips 520 of each housing component 502 abut against tabs 517 to rest at first stop 522a (the first step of the two-step snap closure), thereby holding vial holder 500 into a first configuration by a friction fit. In the first configuration, vial slots 508 are formed and shelves 516 are partially interlocked below each vial slot 508 to receive one or more vials in a stable manner. The first and second housing components 502 are pressed towards each other in a final step such that clips 520 of each housing component 502 clips over tab 517 to rest at second stop 522b (the second step of the two-step snap closure), closing vial holder 500 around each received vial in the fully assembled configuration (FIG. 10, top right).

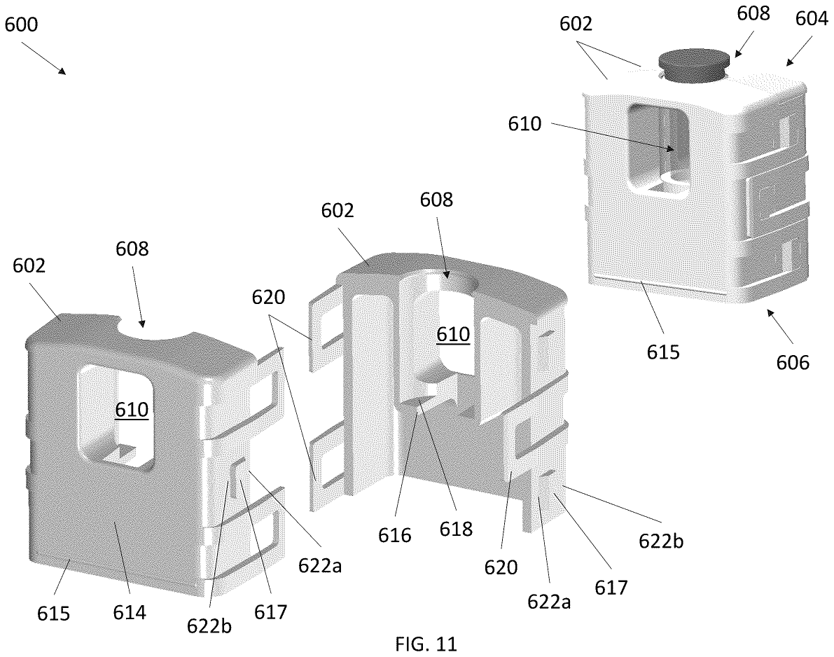

Referring now to FIG. 11, an exemplary vial holder 600 is now described. Similar to vial holder 500, vial holder 600 comprises a housing assembled with a two-step snap closure from two housing components 602 each having a superior end 604 and an inferior end 606. While vial holder 600 is shown with an open inferior end, it should be understood that closed ends and vented ends are also contemplated. Each housing component 602 comprises a shelf 616 positioned inferior to a portion of a vial slot 608, such that a vial inserted into a vial slot 608 may rest upon a superior surface 618 of each shelf 616. Shelf 616 can interlock with a shelf 616 of an opposing housing component 602 to form a larger surface to receive a vial. Inserted vials may be visually inspected through one or more windows 610 connected to each vial slot 608. Vial holder 600 comprises a two-step snap closure mechanism between clips 620 and tabs 617. In the embodiment depicted in FIG. 11, housing component 602 comprises a tab 617 configured to abut against each clip 620 at a first stop 622a with a friction fit and to engage each clip 620 at a second stop 622b, wherein first stop 622a sits at an outer position and second stop 622b sits at an inner position. In some embodiments, vial holder 600 can further comprises one or more interlocking pins and pinholes to enhance rigidity and facilitate assembly. Assembly of vial holder 600 using a first and second housing component 602 into a first configuration and a fully assembled configuration is performed similarly to vial holder 500 described elsewhere herein.

In various embodiments, the vial holders of the present invention can be constructed from any material, including metals, polymeric materials, or combinations of metals or polymeric materials known to persons having skill in the art. Contemplated polymeric materials include but are not limited to polyethylenes, polyamides, polyurethanes, polytetrafluoroethylenes, polycarbonates, polyimides, and combinations thereof. The vial holders of the present invention can be made using any suitable method known in the art. Contemplated methods include but are not limited to milling, casting, and molding. In some embodiments, the methods can include 3D printing or other additive manufacturing techniques commonly used in the art.

The vial holders of the present invention are not limited to the layout and arrangements described with respect to the depicted embodiments. It should be understood that any housing component configured for assembly with a two-step snap closure is contemplated. Vial holders are not limited by the number of available vial slots, which can include 1, 2, 3, 4, 5, 6, 7, 8, 9, 10, or more. Vial slots can be arranged in any desired pattern, including but not limited to linear patterns and grid patterns. Vial holders can be assembled from identical housing components as well as non-identical housing components. Vial holders assembled from identical housing components benefit from reduced tooling costs and increased ease of manufacturing. Identical housing components are also simple to assemble as any two identical housing components may be used, leading to increased supply chain efficiencies.

The present disclosure has been described above by way of example only within the context of the overall disclosure provided herein. It will be appreciated that modifications within the spirit and scope of the claims may be made without departing from the overall scope of the present disclosure.

1. A vial holder, comprising:
a housing comprising a first vial slot and a second vial slot; and
a first shelf and a second shelf positioned inferior to the first vial slot and second vial slot, respectively;
wherein the housing is assembled from a first and an opposing second housing component, each comprising a portion of each vial slot and each shelf;
wherein the housing components are attached to each other by an interior two-step snap closure engagement between at least one clip and at least one clip retainer having an outer detent and an inner detent;
wherein the outer detent of each clip retainer is configured to engage a clip of an opposing housing component in a partially assembled configuration, and wherein the inner detent of each clip retainer is configured to engage a clip of an opposing housing component in a fully assembled configuration.

2. The vial holder of claim 1, wherein the partially assembled configuration partially forms each vial slot to receive a vial therein to rest upon each shelf.

3. The vial holder of claim 2, wherein the fully assembled configuration locks each received vial within each vial slot.

4. The vial holder of claim 1, wherein the at least one clip retainer is integrated into the first shelf portion and the at least one clip extends from the second shelf portion of each housing component.

5. The vial holder of claim 1, wherein the at least one clip retainer and the at least one clip are positioned between the first vial slot and the second vial slot.

6. The vial holder of claim 1, wherein the at least one clip retainer is positioned at two corners of each housing component and the at least one clip is positioned at opposing two corners of each housing component.

7. The vial holder of claim 1, wherein each of the first and second housing component comprises an inner edge that meets face to face in the fully assembled configuration to form a seam.

8. The vial holder of claim 7, wherein each of the first and second housing component comprises a plurality of fins positioned adjacent to and extending outwards past a segment of the inner edge.

9. The vial holder of claim 8, wherein the plurality of fins block the seam formed by the inner edges from exterior access in a fully assembled configuration.

10. The vial holder of claim 9, wherein the plurality of fins forms a tamper-resistant barrier to the two-step snap closure by blocking exterior access.

11. The vial holder of claim 1, wherein each vial slot is connected to at least one window.

12. The vial holder of claim 1, wherein an inferior face of the housing comprises one or more vents fluidly connected to an interior of the housing.

13. The vial holder of claim 1, wherein an exterior surface of the housing is configured to receive one or more labels.

14. The vial holder of claim 1, wherein the first and second housing components are identical.

15. The vial holder of claim 1, wherein the first and second housing components are non-identical.

16. A method of assembling and loading a vial holder, comprising the steps of:
providing a first and second housing component, each housing component comprising a portion of a first vial slot, a second vial slot, a first shelf inferior to the first vial slot, a second shelf inferior to the second vial slot, at least one clip, and at least one clip retainer having an outer detent and an inner detent;
pressing the first and second housing components together such that each clip of each housing component seats within the outer detent of each clip retainer of the opposing housing component to form a partially formed first vial slot, partially formed second vial slot, partially formed first shelf, and partially formed second shelf;
positioning a vial in each of the partially formed first vial slot and partially formed second vial slot to rest on the partially formed first shelf and partially formed second shelf, respectively; and
pressing the first and second housing components together such that each clip of each housing component seats within the inner detent of each clip retainer of the opposing housing component to lock each vial in a fully formed first vial slot and fully formed second vial slot.

17. The method of claim 16, wherein the providing step and first pressing step are performed at a location separate from the positioning step and second pressing step.

18. The method of claim 16, further comprising a step of applying a label to the first housing, the second housing, or both, prior to the positioning step.
